(19) United States
(12) Patent Application Publication
(10) Pub. No.: US 2006/0139974 A1
(43) Pub. Date: Jun. 29, 2006

(54) Power device

(76) Inventor: Daniel Dermark, Landvetter (SE)

Correspondence Address: NIXON & VANDERHYE, PC, 901 NORTH GLEBE ROAD, 11TH FLOOR, ARLINGTON, VA, 22203, US

(21) Appl. No.: 10/560,029

(22) PCT Filed: Jun. 11, 2003
(86) PCT No.: PCT/SE03/00960

§ 371 Date: Dec. 8, 2005

(51) Int. Cl. H02J 1/10

(52) U.S. Cl. 363/65

(57) ABSTRACT

The invention relates to a power device (100), comprising at least a first and a second DC-DC-converter (110, 120, 130), each converter having respective input and output voltages, and respective input and output currents, each converter (110, 120, 130) converting an input DC-voltage level to an output DC-voltage level, each converter comprising input means for a control signal (Vc), the device (100) additionally comprising a control means (140) common to the first and second converters, and arranged to detect a first output voltage (Vtest) at a point (150) in the device which is a common point for the output voltages of the first and second converter (110, 120, 130), the control means (140) delivering a common control signal (Vc) to the control input means of each converter, said common control signal (Vc) being varied according to the level of the voltage at said common point (150).

### TECHNICAL FIELD

The present invention relates to a power device for conversion between different DC-voltage levels.

### BACKGROUND ART

Devices for conversion between different DC/DC-voltage levels are well known. However, traditionally when there has been a need for a conversion involving rather high power levels, the tendency has been to use converters which are also larger physically. In applications where there is a desire for the converters to be small, for example when there is extremely limited space for the circuit boards on which the converters are mounted, the use of larger devices has proven impractical.

### DISCLOSURE OF THE INVENTION

There is thus a need for a device which can convert a first DC-voltage level to a second DC-voltage level, with the device being able to handle rather high power levels, while at the same time occupying a minimal amount of space. In addition, the device should be capable of delivering a stable output voltage regardless of variations in the load connected to the device.

This need is met by the present invention in that the invention discloses a power device comprising at least a first and a second DC-DC-converter, with each converter having respective input and output voltages, and respective input and output currents, each converter converting an input DC-voltage level to an output DC-voltage level, with each converter also comprising input means for a control signal. The device additionally comprises a control means, and the control means are common to the first and second converters and arranged to detect a first output voltage at a point in the device which is a common point for the output voltages of first and second converters, with the control means delivering a common control signal to the control input means of each converter, said common control signal being varied according to the level of the voltage at said common point.

Since the control means are common to the converters and detects the output voltage at a point which is common to the converters, the converters will be controlled to deliver the same output voltage level, as well as the same output current level.

Since the major variations in the output voltage will be likely to occur due to variations in the load to which the output of the device is connected, the control signal which is supplied to the individual converters is suitably arranged to control the output current of the converters, thereby keeping the voltage at said common point essentially constant by controlling the output currents of the converters.

### BRIEF DESCRIPTION OF THE DRAWING

The invention will be described in more detail in the following, with reference to the appended drawing,

FIG. 1, which is an overview of a device according to the present invention.

### EMBODIMENTS

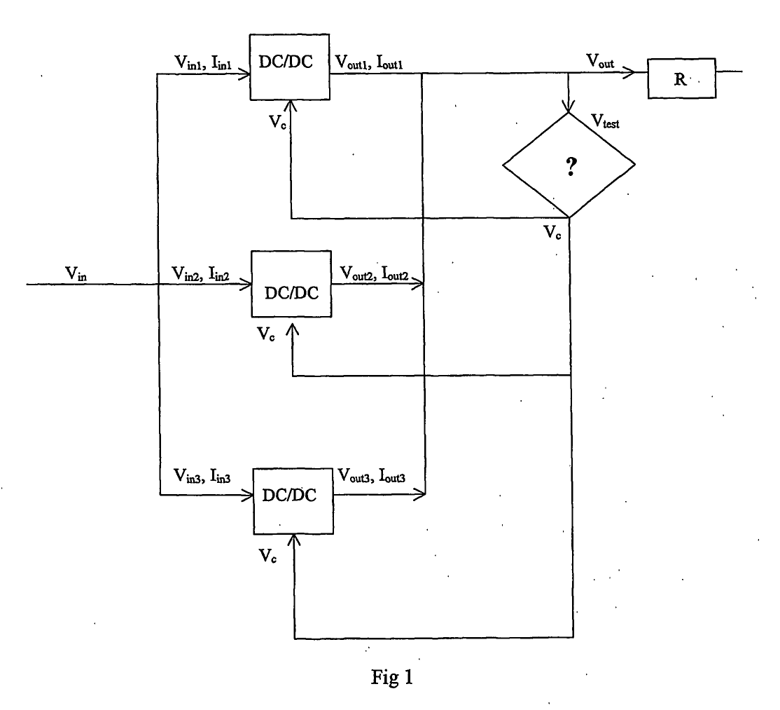

In FIG. 1, a schematic circuit diagram of a device 100 according to the invention is shown. The main purpose of the device 100 is to convert an input DC-voltage level, Vᵢₙ, to an output DC-voltage level, Vₒᵤₜ. The device 100 is intended to be mounted on a printed circuit board, a PCB, and to be small, inexpensive, and easy to assemble. As for the desire for the device to be small, this refers mainly to the “height” of the device, i.e. the physical dimension which extends “upwards” from the PCB.

In addition, there is a need for the device 100 to be able to handle rather large power levels. This need would normally be difficult to combine with the desire for a small device, since DC/DC-converters which can handle large power levels tend to be bulky, thus taking up large amounts of space, and which also leads to such devices being rather difficult to assemble on a standard assembly line.

These two contradictory desires, i.e. large power levels and small devices, is addressed by the device of the invention in that the device makes use of a plurality of smaller DC/DC-converters, with the example shown in FIG. 1 comprising a first 110, a second 120, and a third 130 such converter. The number of individual converters is however, as will be realized by those skilled in the field from the following description, not of primary importance to the invention.

The input voltage, Vin to the device 100 is used as input to all three of the converters, the respective inputs of the converters 110, 120, 130, being referred to respectively as Vᵢₙ₁, Vᵢₙ₂, Vᵢₙ₃.

In a similar manner, the output DC-signals, Vₒᵤₜ₁, Vₒᵤₜ₂, Vₒᵤₜ₃, of the converters comprised in the device 100 are combined into one output DC-voltage, referred to as Vout, said combining of the signals being done by means of the outputs of the converters being connected in one point, referred to as 150 in FIG. 1.

A problem which would normally arise if the outputs of a plurality of DC/DC-converters are combined to produce a common output DC-voltage is that the level of the individual output currents, Iₒᵤₜ₁, Iₒᵤₜ₂, Iₒᵤₜ₃, from the three converters 110, 120, 130 would vary.

This problem is addressed by the present invention in that the device 100 according to the invention comprises a control means 140. The control means can be designed in a variety of manners well known to those skilled in the art, and since the exact nature of the control means is not of primary importance to the invention, the control means will not be described in detail here, only its function will be described.

The control means 140 is arranged to detect a first output DC-voltage, Vₒᵤₜ, at a point 140 in the device 100 where the output voltages of the individual converters 110, 120, 130 comprised in the device come together. The measuring point 150 is thus a common point for all of the three output voltages.

Based on the voltage level, Vₒᵤₜ, which is detected by the control means 140, the control means produce a control signal, V_{c}, said control signal being varied according to the level of the output voltage Vₒᵤₜ. The control signal V_{c} delivered by the control means or circuit 140 is used as an input signal to a control input of each of the first, second and third converters. The control signal is then varied according to the level of Vₒᵤₜ, suitably but not necessarily so that the voltage at the “control point” 150 is kept constant at a desired level.

Since the individual DC/DC-converters 110, 120, 130, of the device 100 share the control means as well as the control signal, the converters will always be controlled to deliver the same output current. This is important, since this makes it possible to utilize each individual converter to its maximum capacity, thus making it possible to choose converters which are smaller physically than would otherwise have been possible. This in turn makes it possible to keep down the size of the device 100, which was an object of the invention.

Preferably, the control signal V_{c} from the control means 140 is used to control the output current of the individual converters, suitably so that a constant desired DC-voltage is maintained at the common point 140 in the device 100.

1. A power device (100), comprising at least a first and a second DC-DC-converter (110, 120, 130), with each converter having respective input (Vᵢₙ₁, Vᵢₙ₂, Vᵢₙ₃) and output (Vₒᵤₜ₁, Vₒᵤₜ₂, Vₒᵤₜ₃) voltages and respective input and output currents (Iₒᵤₜ₁, Iₒᵤₜ₂, Iₒᵤₜ₃), each converter (110, 120, 130) converting an input DC-voltage level (Vᵢₙ, Vᵢₙ₂, Vᵢₙ₃) to an output DC-voltage level (Vₒᵤₜ₁, Vₒᵤₜ₂, Vₒᵤₜ₃), with each converter also comprising input means for a control signal (V_{c}), the device (100) additionally comprising a control means (140), characterized in that said control means (140) are common to the first and second converters and arranged to detect a first output voltage (Vₜₑₛₜ) at a point (150) in the device which is a common point for the output voltages (Vₒᵤₜ₁, Vₒᵤₜ₂, Vₒᵤₜ₃) of the first and second converter (110, 120, 130), with the control means (140) delivering a common control signal (V_{c}) to the control input means of each converter, said common control signal (V_{c}) being varied according to the level of the voltage at said common point (150).

2. The power device of claim 1, in which the control signal (V_{c}) to each converter (110, 120, 130) is arranged to control the output current of the converter.

3. The power device of claim 2, in which the voltage at said common point (150) is kept essentially constant by controlling the output currents of the converters (110, 120, 130) to be essentially equal.
